(19) United States
(12) Patent Application Publication
(10) Pub. No.: US 2019/0200526 A1
(43) Pub. Date: Jul. 4, 2019

(54) DOUBLE WINDROW CONVERTER

(71) Applicant: James E. Ferch, Montana, MT (US)

(72) Inventor: James E. Ferch, Montana, MT (US)

(21) Appl. No.: 16/296,725

(22) Filed: Mar. 8, 2019

(51) Int. Cl. A01D 78/00; A01D 78/16

(52) U.S. Cl. CPC A01D 78/002; A01D 78/16

(57) ABSTRACT

The embodiments herein provide a double windrow converter assembly. The double windrow converter assembly is removably attachable behind a towing vehicle or a swather. The converter enables creation of a double windrow of freshly cut hay (with high moisture content). The converter picks up the freshly cut hay windrow using a pickup head which is then diverted to a trough. The hay collected in the trough is discharged on one side of the field to create a first half of the double swath. The swather and the double windrow converter assembly are then operated in opposite direction to generate second half of double swath. Thus, use of the double windrow converter assembly along with swather helps in accomplishing two tasks/operations in a single pass. The assembly also eliminates need for using a rake to pick up dried hay from the field on waiting for a few days after swathing.

### BACKGROUND

### Technical Field

The embodiments herein are generally related to the field of agricultural production. The embodiments herein are particularly related to a freshly cut hay windrow handling assembly. The embodiments herein are more particularly related to a double windrow converter assembly removably attachable to a towing vehicle.

### Description of the Related Art

In modern day agricultural techniques, forage crop material such as hay is cut by a swather that lays it down on the fields in swaths/windrows. The swaths are then allowed to dry for a couple of days on the field to be later collected by a rake. Rake collects the dried grass in a single row to form a double swath. Typical raking equipments used for this purpose comprise a plurality of horizontally extending bars with tooth extending vertically downward. The bars with tooth move to drag the hay within the windrow to either side thus forming a double windrow.

Thus, raking is carried out only after the hay dries up (on waiting for a few days) as raking equipments do not work properly on hay with high moisture content. Also, the freshly cut hay rolls up in a rope-like windrow that does not dry properly. Double windrow is necessary for making a large round or square bale. Moreover, most rakes that are used in recent times are drawn by a tractor which must drive over a part of the swath just prior to raking. Further, this whole process of collecting the hay requires multiple equipments to be used such as swather, rake, tractor etc. This also requires multiple pass of these equipments in the field which consumes time, additional fuel and thus is not cost effective.

Hence, there is a need for providing a double windrow converter that enables creation of a double windrow of freshly cut hay (with high moisture content). There is also a need for providing a double windrow converter assembly that is removably attachable behind a towing vehicle such as swather. Further, there is a need for a double windrow converter that eliminates the need for usage of plurality of equipments and in-turn multiple pass of these equipments on the field to generate double windrow.

The above mentioned shortcomings, disadvantages and problems are addressed herein and which will be understood by reading and studying the following specification.

### Objects of the Embodiments Herein

The primary object of the embodiments herein is to provide a double windrow converter that enables creation of double windrow of the freshly cut hay (high moisture content).

Another object of the embodiments herein is to provide a double windrow converter that avoids generation of rope-like windrow which gets formed when high moisture hay is collected to create double windrow.

Yet another object of the embodiments herein is to provide a double windrow converter assembly removably attachable behind a towing vehicle such as swather.

Yet another object of the embodiments herein is to provide a double windrow converter that eliminates the need for usage of plurality of equipments to generate double windrow.

Yet another object of the embodiments herein is to provide a double windrow converter that eliminates the need for doing multiple pass on the field using different equipments to generate double windrow.

Yet another object of the embodiments herein is to provide a double windrow converter that is cost effective and time saving as compared to existing solutions while generating the double windrow.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The various embodiments herein provide a double windrow converter assembly removably attachable to a swather. The double windrow convertor assembly is configured for creating a double swath/windrow of the freshly cut hay from a field. The double windrow convertor assembly comprises a pickup head comprising of a plurality of pickup teeth. The plurality of pickup teeth are configured for picking up freshly slathered hay from the field due to rotational movement of the pickup head. The assembly also comprises a trough placed above the pickup head. The trough comprises a delivery end and a discharge end. The hay picked up by the pickup head gets collected at the delivery end of the trough. The assembly further comprises an endless belt mounted over the trough. The endless belt is configured for rotating in a direction perpendicular to the movement of plurality of pickup teeth. The endless belt comprises a plurality of teeth affixed on to the outer surface. The rotation of the plurality of teeth on the endless belt diverts the hay collected at the delivery end of the trough to the discharge end. The discharge end of the trough is configured for discharging the hay onto the field towards an either side of the swather to create the double windrow.

According to an embodiment herein, the double windrow convertor assembly further comprises a first hydraulic motor configured for providing a desired rotational movement to the pickup head. The first hydraulic motor and the pickup head are connected via a first endless chain.

According to an embodiment herein, the double windrow convertor assembly further comprises a second hydraulic motor configured for providing a desired rotational movement to the endless belt. The second hydraulic motor and the endless belt are connected via a second endless chain.

According to an embodiment herein, the double windrow convertor assembly further comprises a base frame configured for providing a stable base for mounting the pickup head, trough, endless belt and the first and second hydraulic motors.

According to an embodiment herein, the base frame further comprises one or more connection points/hitch configured for enabling mechanical connection between the double windrow converter assembly and the swather.

According to an embodiment herein, the double windrow converter assembly further comprises a plurality of wheels and a steel axle coupled at the base of the base frame. The plurality of wheels and a steel axle are configured for enabling movement of the windrow convertor assembly in synchronization with the swather in a desired direction.

According to an embodiment herein, the double windrow converter assembly further comprises a hay stripper placed above the discharge end of the trough. The hay stripper is configured for preventing the hay from going around the dragging teeth above the discharge end of the trough.

According to an embodiment herein, the double windrow converter assembly further comprises a tensioner assembly mounted on the telescoping frame. The tensioner assembly comprises a tensioner threaded bolt, a spring and one or more nuts. The tensioner assembly is configured for providing required amount of endless belt tension necessary for proper operation of the assembly.

According to an embodiment herein, a method for creating a double windrow of freshly cut hay using a double windrow converter is provided. The method comprises the steps of attaching a double windrow converter assembly to a swather using one or more connection points/hitch. The method also comprises operating the swather and the windrow converter assembly in a particular direction for generating the windrow. The method further comprises picking up the swather generated fresh hay windrow using the pickup head provided in the double windrow converter assembly. The method still further comprises collecting the picked up hay in a delivery end of a trough provided in the double windrow converter assembly. The method still further comprises diverting the collected hay towards the discharge end of the trough using an endless belt provided in the double windrow converter assembly and discharging the hay on one side of the field to create a first half of the double swath.

According to an embodiment herein, the method further comprises the step of operating the swather and the double windrow converter assembly in the opposite direction to generate the second half of the double swath.

According to an embodiment herein, the method further comprises the step of powering on a first hydraulic motor to actuate rotational movement of the pickup head. The rotational movement of the pickup head in-turn causes rotational movement of a plurality of pickup teeth. The rotational movement of the plurality of pickup teeth picks up freshly swathed hay from the field.

According to an embodiment herein, the method further comprises the step of powering on a second hydraulic motor to actuate rotational movement of the endless belt. The rotational movement of the endless belt in-turn causes rotational movement of a plurality of teeth. The rotational movement of the plurality of teeth diverts the collected hay towards the discharge end of the trough.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a top view of the double windrow converter assembly, according to an embodiment herein.

FIG. 2 illustrates a right side view of the double windrow converter assembly, according to an embodiment herein.

FIG. 3 illustrates a front view of the double windrow converter assembly, according to an embodiment herein.

FIG. 4 illustrates a flow chart explaining a method for creating double windrow of freshly cut hay using a double windrow converter assembly, according to an embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a double windrow converter assembly removably attachable to a swather. In one example embodiemnt, the converter assembly is removably attachable to a swather, a tractor or to any other towing vehicle. The double windrow convertor assembly is configured for creating a double swath/windrow of the freshly cut hay from a field. The double windrow convertor assembly comprises a pickup head comprising of a plurality of pickup teeth. The plurality of pickup teeth are configured for picking up freshly slathered hay from the field due to rotational movement of the pickup head. The assembly also comprises a trough placed above the pickup head. The trough comprises a delivery end and a discharge end. The hay picked up by the pickup head gets collected at the delivery end of the trough. The assembly further comprises an endless belt mounted over the trough. The endless belt is configured for rotating in a direction perpendicular to the movement of plurality of pickup teeth. The endless belt comprises a plurality of teeth affixed on to the outer surface. The rotation of the plurality of teeth on the endless belt diverts the hay collected at the delivery end of the trough to the discharge end. The discharge end of the trough is configured for discharging the hay onto the field towards an either side of the swather to create the double windrow.

According to an embodiment herein, the double windrow convertor assembly further comprises a first hydraulic motor configured for providing a desired rotational movement to the pickup head. The first hydraulic motor and the pickup head are connected via a first endless chain.

According to an embodiment herein, the double windrow convertor assembly further comprises a second hydraulic motor configured for providing a desired rotational movement to the endless belt. The second hydraulic motor and the endless belt are connected via a second endless chain.

According to an embodiment herein, the double windrow convertor assembly further comprises a base frame configured for providing a stable base for mounting the pickup head, trough, endless belt and the first and second hydraulic motors.

According to an embodiment herein, the base frame further comprises one or more connection points/hitch configured for enabling mechanical connection between the double windrow converter assembly and the swather.

According to an embodiment herein, the double windrow converter assembly further comprises a plurality of wheels and a steel axle coupled at the base of the base frame. The plurality of wheels and a steel axle are configured for enabling movement of the windrow convertor assembly in synchronization with the swather in a desired direction.

According to an embodiment herein, the double windrow converter assembly further comprises a hay stripper placed above the discharge end of the trough. The hay stripper is configured for preventing the hay from going around the dragging teeth above the discharge end of the trough.

According to an embodiment herein, the double windrow converter assembly further comprises a tensioner assembly mounted on the telescoping frame. The tensioner assembly comprises a tensioner threaded bolt, a spring and one or more nuts. The tensioner assembly is configured for providing required amount of endless belt tension necessary for proper operation of the assembly.

According to an embodiment herein, a method for creating a double windrow of freshly cut hay using a double windrow converter is provided. The method comprises the steps of attaching a double windrow converter assembly to a swather using one or more connection points/hitch. The method also comprises operating the swather and the windrow converter assembly in a particular direction for generating the windrow. The method further comprises picking up the swather generated fresh hay windrow using the pickup head provided in the double windrow converter assembly. The method still further comprises collecting the picked up hay in a delivery end of a trough provided in the double windrow converter assembly. The method still further comprises diverting the collected hay towards the discharge end of the trough using an endless belt provided in the double windrow converter assembly and discharging the hay on one side of the field to create a first half of the double swath.

According to an embodiment herein, the method further comprises the step of operating the swather and the double windrow converter assembly in the opposite direction to generate the second half of the double swath.

According to an embodiment herein, the method further comprises the step of powering on a first hydraulic motor to actuate rotational movement of the pickup head. The rotational movement of the pickup head in-turn causes rotational movement of a plurality of pickup teeth. The rotational movement of the plurality of pickup teeth picks up freshly swathed hay from the field.

According to an embodiment herein, the method further comprises the step of powering on a second hydraulic motor to actuate rotational movement of the endless belt. The rotational movement of the endless belt in-turn causes rotational movement of a plurality of teeth. The rotational movement of the plurality of teeth diverts the collected hay towards the discharge end of the trough.

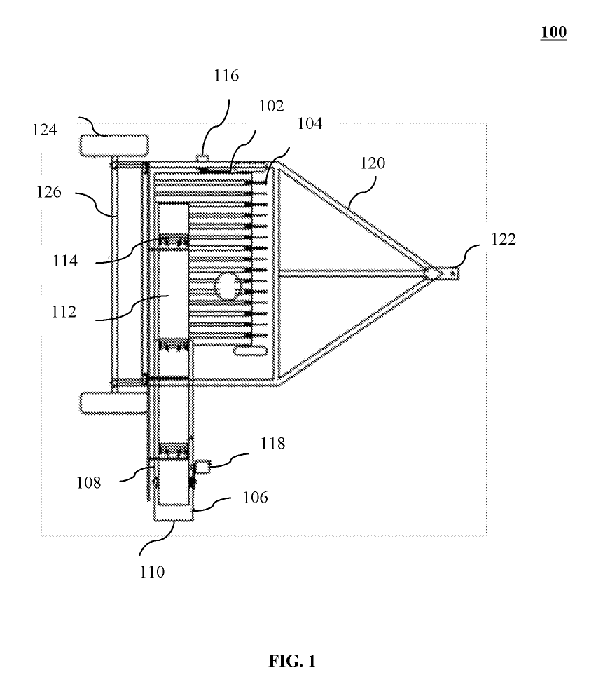

FIG. 1 illustrates a top view of the double windrow converter assembly, according to an embodiment herein. With respect to FIG. 1, the assembly comprises the pickup head 102 comprising of the plurality of pickup teeth 104. The plurality of pickup teeth 104 are configured for picking up freshly swathed hay from the field due to rotational movement of the pickup head 102. The assembly also comprises the trough 106 placed above the pickup head 102. The trough 106 comprises the delivery end 108 and the discharge end 110. The hay picked up by the pickup head 102 gets collected at the delivery end 108 of the trough 106. The assembly further comprises the endless belt 112 mounted over the trough 106. The endless belt 112 is configured for rotating in a direction perpendicular to the movement of plurality of pickup teeth 104. The endless belt 112 comprises a plurality of teeth 114 affixed on to the outer surface. The rotation of the plurality of teeth 114 on the endless belt 112 diverts the hay collected at the delivery end 108 of the trough to the discharge end 110. The discharge end 110 of the trough 106 is configured for discharging the hay onto the field towards an either side of the swather. The either side of the swather represents the uncut side of the field or to a last swath cut side.

According to an embodiment herein, the assembly further comprises the first hydraulic motor 116 configured for providing a desired rotational movement to the pickup head 102. The first hydraulic motor 116 and the pickup head 102 are connected via a first endless chain (not shown).

According to an embodiment herein, the assembly further comprises the second hydraulic motor 118 configured for providing a desired rotational movement to the endless belt 112. The second hydraulic motor 118 and the endless belt 112 are connected via a second endless chain (not shown).

According to an embodiment herein, the assembly further comprises the base frame 120 configured for providing a stable base for mounting the pickup head 102, trough 106, endless belt 112 and the first and second hydraulic motors 116 and 118. The base frame 120 further comprises one or more connection points/hitch 122 configured for enabling mechanical connection between the double windrow converter assembly and the swather.

According to an embodiment herein, the assembly further comprises the plurality of wheels 124 and the steel axle 126 coupled at the base of the base frame 120. The plurality of wheels 124 and the steel axle 126 are configured for enabling movement of the windrow convertor assembly in synchronization with the swather in a desired direction.

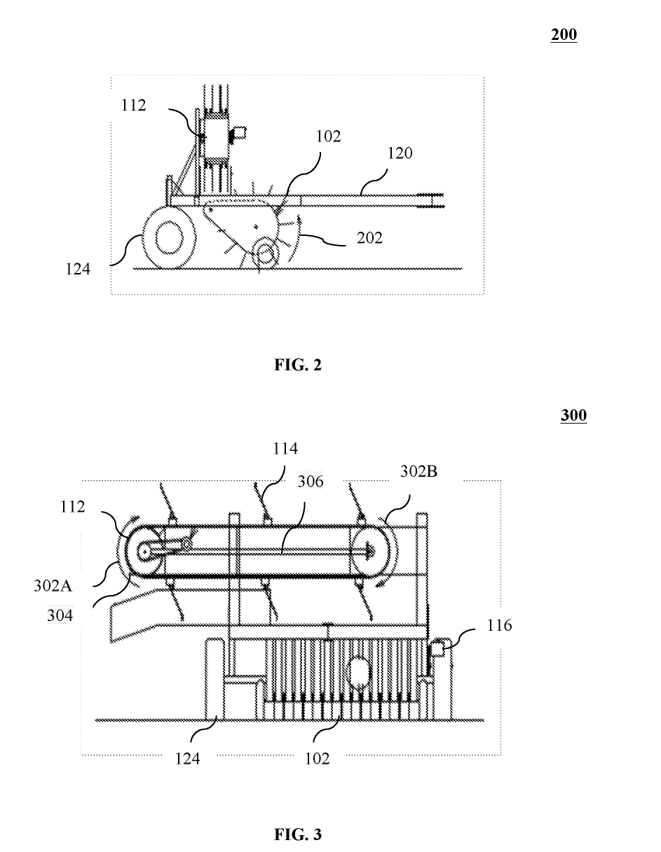

FIG. 2 illustrates a right side view of the double windrow converter assembly, according to an embodiment herein. With respect to FIG. 2, the pickup head 102, the wheels 124, and the base frame 120 and the endless belt 112 are shown. The reference numeral 202 shows the rotational movement of the pickup head 102 and the teeth 104 that in turn picks up the freshly cut hay from the field.

FIG. 3 illustrates a front view of the double windrow converter assembly, according to an embodiment herein. With respect to FIG. 3, the pickup head 102, the plurality of tooth 114 on the endless belt 112, the first hydraulic motor 116 are shown. The reference numeral 302A and 302B shows the rotational movement of the endless belt 112 and the teeth 114 that in turn collects the picked up the hay towards the delivery end 108 of the trough 106. The double windrow converter assembly also comprises a hay stripper 304 placed above the discharge end 110 of the trough 106. The hay stripper 304 is configured for preventing the hay from going around the dragging teeth 114 above the discharge end 110 of the trough 106. The double windrow converter assembly further comprises a tensioner assembly 306 mounted on the telescoping frame. The tensioner assembly 306 comprises a tensioner threaded bolt, a spring and one or more nuts. The tensioner assembly 306 is configured for providing required amount of endless belt tension necessary for proper operation of the assembly.

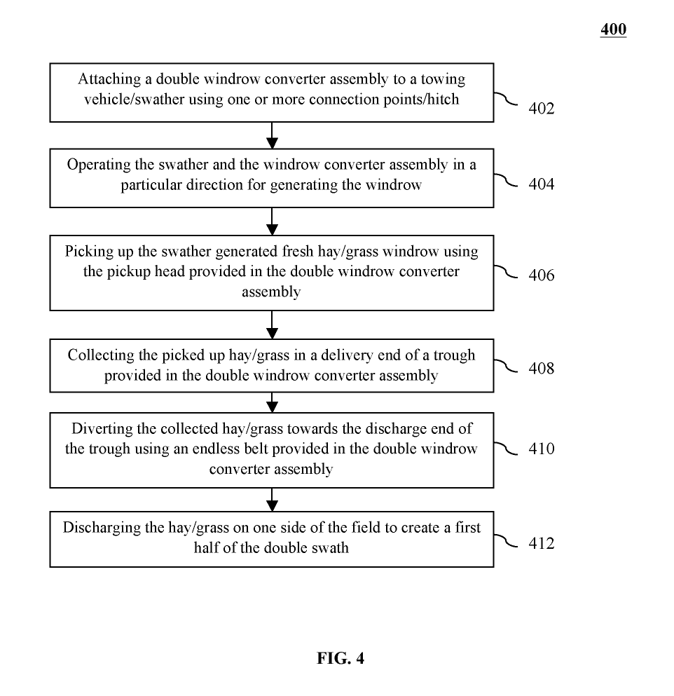

FIG. 4 illustrates a flow chart explaining a method for creating double windrow of freshly cut hay using a double windrow converter assembly, according to an embodiment herein. With respect to FIG. 4, the method comprises the steps of attaching a double windrow converter assembly to a swather using one or more connection points/hitch (402). The method also comprises operating the swather and the windrow converter assembly in a particular direction for generating the windrow (404). The method further comprises picking up the swather generated fresh hay windrow using the pickup head provided in the double windrow converter assembly (406). The method still further comprises collecting the picked up hay in a delivery end of a trough provided in the double windrow converter assembly (408). The method still further comprises diverting the collected hay towards the discharge end of the trough using an endless belt provided in the double windrow converter assembly (410). The method still further comprises discharging the hay on one side of the field to create a first half of the double swath (412).

According to an embodiment herein, the step of operating the swather and the double windrow converter assembly in the opposite direction to generate the second half of the double swath. The method further comprises the step of powering on a first hydraulic motor to actuate rotational movement of the pickup head. The rotational movement of the pickup head in-turn causes rotational movement of a plurality of pickup teeth. The rotational movement of the plurality of pickup teeth picks up freshly swathed hay from the field. The method further comprises the step of powering on a second hydraulic motor to actuate rotational movement of the endless belt. The rotational movement of the endless belt in-turn causes rotational movement of a plurality of teeth. The rotational movement of the plurality of teeth diverts the collected hay towards the discharge end of the trough.

Therefore, the embodiments herein provide a double windrow converter assembly. The double windrow converter assembly is removably attachable behind a towing vehicle or a swather. The converter enables creation of a double windrow of freshly cut hay (with high moisture content). The double windrow converter assembly along with swather helps in accomplishing two tasks/operations in a single pass. The assembly also eliminates need for using a rake to pick up dried hay from the field on waiting for a few days after swathing. The double windrow converter assembly is useful in agricultural production.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be the to fall there between.

What is claimed is:

1. A double windrow converter assembly removably attachable to a swather, wherein the double windrow convertor assembly is configured for creating a double windrow of freshly cut hay from a field, and wherein the double windrow convertor assembly comprises:
a pickup head comprising a plurality of pickup teeth, wherein the plurality of pickup teeth are configured for picking up freshly slathered hay from the field due to rotational movement of the pickup head;
a trough placed above the pickup head, wherein the trough comprises a delivery end and a discharge end, and wherein the hay picked up by the pickup head gets collected at the delivery end of the trough; and
an endless belt mounted over the trough, wherein the endless belt is configured for rotating in a direction perpendicular to the movement of plurality of pickup teeth, and wherein the endless belt comprises a plurality of teeth affixed on to an outer surface, and wherein the rotation of the plurality of teeth on the endless belt diverts the hay collected at the delivery end of the trough to the discharge end, and wherein the discharge end of the trough is configured for discharging the hay onto the field towards an either side of the swather to create the double windrow.

2. The double windrow converter according to claim 1, wherein the double windrow convertor assembly further comprises a first hydraulic motor, and wherein the first hydraulic motor is configured for providing a desired rotational movement to the pickup head, and wherein the first hydraulic motor and the pickup head are connected via a first endless chain.

3. The double windrow converter according to claim 1, wherein the double windrow convertor assembly further comprises a second hydraulic motor, and wherein the second hydraulic motor is configured for providing a desired rotational movement to the endless belt, and wherein the second hydraulic motor and the endless belt are connected via a second endless chain.

4. The double windrow converter according to claim 1, wherein the double windrow convertor assembly further comprises a base frame, and wherein the base frame is configured for providing a stable base for mounting the pickup head, trough, endless belt and the first and the second hydraulic motors.

5. The double windrow converter according to claim 4, wherein the base frame further comprises one or more connection points/hitch, and wherein the one or more connection points are configured for enabling mechanical connection between the double windrow converter assembly and the swather.

6. The double windrow converter according to claim 1, wherein the double windrow converter assembly further comprises a plurality of wheels and a steel axle coupled at the base of the base frame, and wherein the plurality of wheels and a steel axle are configured for enabling movement of the windrow convertor assembly in synchronization with the swather in a desired direction.

7. The double windrow converter according to claim 1, wherein the double windrow converter assembly further comprises a hay stripper placed above the discharge end of the trough, and wherein the hay stripper is configured for preventing the hay from going around the dragging teeth above the discharge end of the trough.

8. The double windrow converter according to claim 1, wherein the double windrow converter assembly further comprises a tensioner assembly mounted on the telescoping frame, and wherein the tensioner assembly comprises a tensioner threaded bolt, a spring and one or more nuts, and wherein the tensioner assembly is configured for providing required amount of endless belt tension necessary for proper operation of the assembly.

9. A method for creating a double windrow of freshly cut hay using a double windrow converter, the method comprising the steps of:
attaching a double windrow converter assembly to a swather using one or more connection points/hitch;
operating the swather and the windrow converter assembly in a particular direction for generating the windrow;
picking up the swather generated fresh hay windrow using the pickup head provided in the double windrow converter assembly;
collecting the picked up hay in a delivery end of a trough provided in the double windrow converter assembly;
diverting the collected hay towards the discharge end of the trough using an endless belt provided in the double windrow converter assembly; and
discharging the hay on one side of the field to create a first half of the double swath.

10. The method according to claim 9, wherein the method further comprises the step of operating the swather and the double windrow converter assembly in the opposite direction to generate the second half of the double swath.

11. The method according to claim 9, wherein the method further comprises the step of powering on a first hydraulic motor to actuate rotational movement of the pickup head, and wherein the rotational movement of the pickup head in-turn causes rotational movement of a plurality of pickup teeth, and wherein the rotational movement of the plurality of pickup teeth picks up freshly swathed hay from the field.

12. The method according to claim 9, wherein the method further comprises the step of powering on a second hydraulic motor to actuate rotational movement of the endless belt, and wherein the rotational movement of the endless belt in-turn causes rotational movement of a plurality of teeth, and wherein the rotational movement of the plurality of teeth diverts the collected hay towards the discharge end of the trough.
